(19) United States
(12) Patent Application Publication
(10) Pub. No.: US 2017/0099026 A1
(43) Pub. Date: Apr. 6, 2017

(54) SOLAR CONCENTRATOR COMPRISING FLAT MIRRORS ORIENTED NORTH-SOUTH AND A CYLINDRICAL-PARABOLIC SECONDARY MIRROR HAVING A CENTRAL ABSORBER

(71) Applicant: Eduardo David MENDEL HORWITZ, Santiago (CL)

(72) Inventor: Eduardo David MENDEL HORWITZ, Santiago (CL)

(21) Appl. No.: 15/128,059

(22) PCT Filed: Mar. 19, 2015
(86) PCT No.: PCT/CL2015/000015

§ 371 Date: Sep. 21, 2016

(30) Foreign Application Priority Data
Mar. 21, 2014 (CL) 713-2014

(51) Int. Cl. H02S 10/00; H02S 40/44; F24J 2/38; F24J 2/10; F24J 2/16; F24J 2/18; H02S 20/32; F24J 2/07

(52) U.S. Cl. CPC H02S 10/00; H02S 20/32; H02S 40/44; F24J 2/07; F24J 2/10; F24J 2/16; F24J 2/18; F24J 2/38

(57) ABSTRACT

The invention relates to a solar power concentrator (CSP) formed by a series of long flat (Fresnel-type) mirrors oriented in a north-south direction, each mirror having a single east-west axis of rotation, tracking the height of the sun. Together the mirrors reflect the light throughout the day towards a single cylindrical-parabolic mirror which concentrates the solar radiation onto a small area close to the focal line of the parabola on which an absorber is located that heats fluids and/or generates electricity.

The present invention consists in a Solar Power Concentrator (CSP), formed of a set of lengthy flat mirrors (Fresnel like) oriented in direction North-South, each of them with just one East-West axis of rotation following the sun's altitude, jointly reflecting the light over the day onto one parabolic trough mirror, which concentrates the solar radiation onto a small region around the parabolas focal line, in which one places an absorber that heats up fluids.

### BACKGROUNDS

CSPs with flat mirrors placed like an amphitheater focusing to a central tower have already been developed, which need for each mirror a tracking system in two axis, while this invention just needs tracking on one axis.

There also exist CSPs with Fresnel like flat mirrors, in which these only have one rotation axis to follow the sun, but with rotation axis South-North. As the sun in winter or middle seasons has a low inclination, the reflected light will also fall onto a parabolic trough mirror but at much larger distances (and on much smaller incident angles) than on this invention, thus requiring much more precision for the set of mirrors. The tracking angle in which the set of mirrors has to rotate in these cases is also greater than in the present invention, specially in relevant hours of maximal radiation.

### BRIEF FIGURE DESCRIPTION

For a better understanding of the invention, it will be described in base of a embodiment, which is illustrated in the figures, which just has an illustrative character, without limiting the purpose of the invention, nor its dimensions, the amount of illustrated elements or the holding means.

FIG. 1: is a lateral view of the rows of flat mirrors (1) reflecting the solar light coming from an inclination angle of 30°, placed in angles such as to reflect the light onto a zone (2) with a parabolic trough placed on a tower. This radiation concentrates and is absorbed in a region around the axis of the parabola (3) in which the liquid to be heated circulates.

FIG. 2: is another lateral view of the system, but now with the sun at an inclination of 90°. The flat mirrors have been rotated with respect to the ones in FIG. 1, each one by an angle such that the suns reflection continues to shine on the secondary parabolic trough mirror.

FIG. 3: is an upper view of the rows of plane mirrors (1), each one in the appropriate angle to make the light reflection shine on the parabolic trough mirror (2) (for earth's southern hemisphere). While the sun moves from East to West, light reflects in various lateral angles, but always shining by parallelism on the secondary parabolic trough mirror for then being concentrated on the absorber.

FIG. 4: is a cross-section view in more detail of the secondary parabolic trough mirror, showing the radiation coming from two flat mirrors (A being the furthest and B the closest to the tower) and a possible distribution of tubes or panels, which absorb the radiation and prevent as well as possible the heat emission.

FIG. 5: is a cross-section view of the flat mirrors, with which it is easy to prove that all these mirrors move by the same angle Δγ=−Δα/2 when the suns altitude changes by an angle Δα, therefore needing just one tracking system common to all the mirrors.

### DETAILED DESCRIPTION OF THE INVENTION

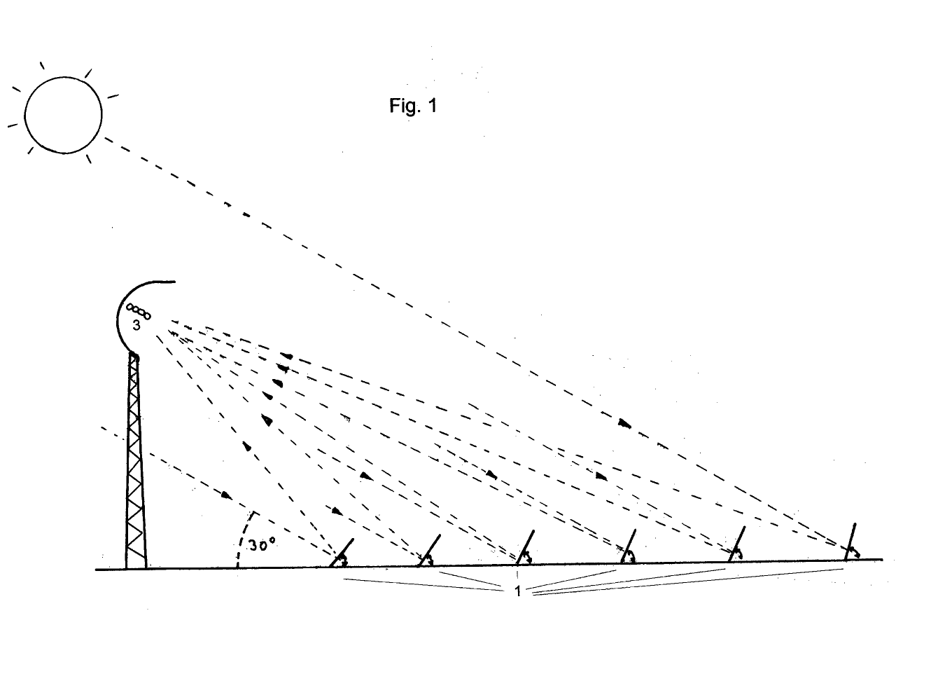

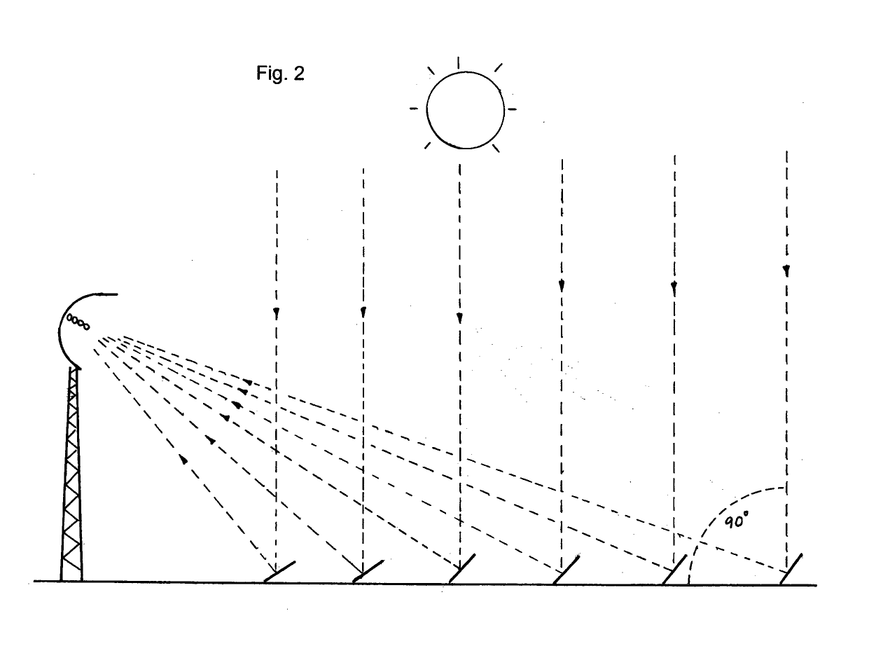

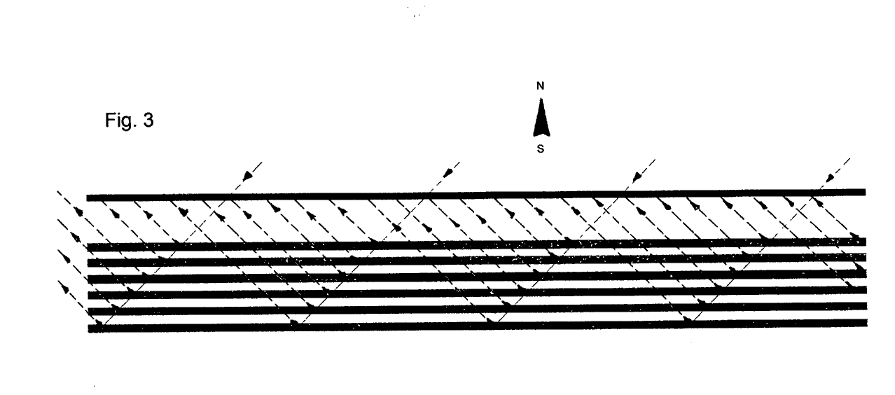

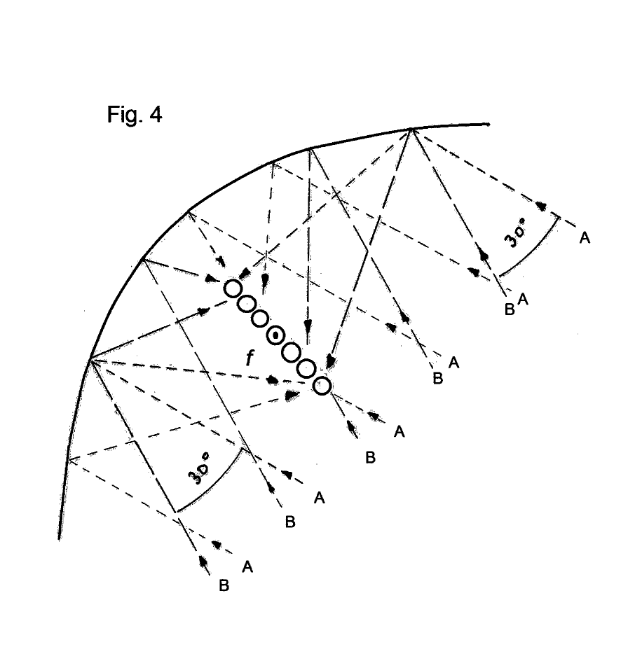

The flat mirrors (1) are mounted in a frame that can rotate on one axis with a control system, such as always to reflect the light onto a elongated stripe in direction East-West (2), in which one places a secondary parabolic trough mirror mounted on a tower, as one can see in FIGS. 1 and 2. Provided that all the rows of mirrors reflect light within an angle of approximately 30° from the point of view of the parabola of the secondary mirror, it has been shown that the image should concentrate on a narrow region contained in an ellipse over the parabolic axis (see the patent application 272-2009 in Chile with date Feb. 2, 2009 to enclose the area of the absorber) as one sees in FIG. 4. If the morning or afternoon light arrives in a lateral angle with respect to the flat mirrors, the reflexion will simply happen by parallelism on further points along the parabolic trough as one appreciates in FIG. 3, but within the same elliptic region around the focal point of the parabola of this concentrating mirror.

Within this elliptic stripe an absorber (3) is installed, which consists in tubes or ducts with good solar radiation absorption properties and low thermal emission. The tubes contain the liquid or gas which is pumped to a reservoir as soon as the temperature differential is convenient, and with a heat exchanger the thermal energy in the reservoir keeps increasing.

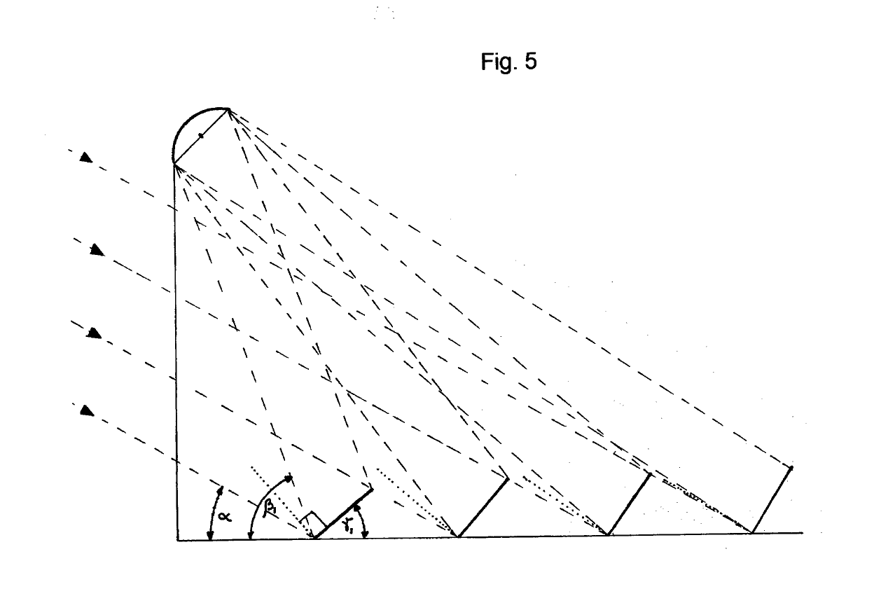

The flat mirrors with this geometry keep the light focused on to the parabolic trough during the day and over the year with the need of just one tracking system common to all the mirrors, as the initial angles γᵢ in FIG. 5, for a given solar altitude, are different due to the growing distances to the tower (resulting in different β), but the rotation of each of the mirrors changes by the same angle:

Δγ=: γ_{f}−γᵢ=(90°−(β+α_{f})/2)−(90°−(β+αᵢ)/2)=(−α_{f}+αᵢ)/2=:−Δα/2

For example, the rotation of the flat mirrors between FIGS. 1 and 2, with the sun coming from angles 30° and 90° respectively, is for each Δγ=30°.

A possible system to track the sun consists simply in fixing to each flat mirror axis a gearwheel, and over all these gearwheels a horizontal dented rail with a sufficient length to rotate all the mirrors by the same amount, with a precision motor guided by a single computational control system and/or with sensors that get the solar position.

The solar concentration reached with this simple system of flat mirrors is then a multiple of the direct radiation that would be obtained directly with just the parabolic trough, the amount depending essentially on the height of the tower which determines the amount of terrain that can be covered with mirrors within the 30° from the tower previously mentioned.

In principle, this stays true while the tracking system and the precision of the mirrors is sufficiently good, in order to focus the beam on the secondary mirror. (It is possible to design the secondary mirror somewhat high-wise wider than the original beam from the flat mirrors in order not to lose radiation).

Within the narrow elliptic stripe (3) along the focal line of the parabolic trough mirror, the light reflected by this mirror and the set of flat mirrors gets concentrated. In this area the absorber is installed, consisting in a series of tubes with selective paint or vacuum tubes, in order to absorb the maximum of solar radiation and prevent the emission of thermal energy in the infrared. In these tubes, water, oil or gases can circulate, which are taken to a reservoir with a heat exchanger. Alternatively, other type of absorbers or cavities can be placed on the stripe of high solar radiation.

This thermal heat can be used to heat up water in large quantities and/or to produce electricity (for example with a vapor turbine or with a Stirling machine) and/or to produce distilled water (for example from sea water).

1. A solar power concentrator that allows the efficient concentration of solar radiation, wherein a set of flat mirrors (1) with an East-West axis of rotation, coordinated among them and with the sun's elevation, so as to reflect the radiation to the North (in the southern hemisphere) to an elevated, narrow and elongated region on an East-West horizontal axis (2) in which an absorber is placed, or in which the radiation is further concentrated.

2. A concentrator according to claim 1, wherein the region (2) being a parabolic trough mirror, which concentrates further the solar radiation within an elliptic stripe around the axis of the parabola and centered on its focal point, where the absorber is placed, for which the angle between the beams reflected from the furthest flat mirror (A) and closest (B) to the focal line of the parabolic trough does not surpass the 30°.

3. A concentrator according to claim 1, wherein the axes of the flat mirrors having gearwheels and a horizontal geared rail moved by a motor, so that it rotates all the mirrors by the same angle Δγ=Δα/2 when the sun's altitude changes by Δα, as required for the geometric configuration of mirrors given by this invention.

4. A concentrator according to claim 1 having as absorber of the radiation two parallel strips of photovoltaic plates, centered on the focal line of the parabolic trough, with opposite faces pointing each one towards the incident radiation and attached from their back to the tubes or ducts with fluid, which absorb and diffuse the heat produced on the electricity generating panels.
